(19) United States
(12) Patent Application Publication
(10) Pub. No.: US 2016/0076477 A1
(43) Pub. Date: Mar. 17, 2016

(54) Fuel Injector

(71) Applicant: INTERNATIONAL ENGINE INTELLECTUAL PROPERTY COMPANY, LLC, Lisle, IL (US)

(72) Inventors: William Yunbiao Shen, Westmont, IL (US); Keith Steven Schulz, Columbia, SC (US); Erik Jordan Hansen, Ann Arbor, MI (US)

(73) Assignee: International Engine Intellectual Property Company, LLC, Lisle, IL (US)

(21) Appl. No.: 14/786,916

(22) PCT Filed: Apr. 25, 2013
(86) PCT No.: PCT/US13/38199

§ 371 Date: Oct. 23, 2015

(51) Int. Cl. F02D 41/30; F02D 41/38; F02M 61/18; F02M 51/06; F02M 61/10

(52) U.S. Cl. CPC F02D 41/3005; F02M 51/06; F02M 61/10; F02M 61/1806; F02D 41/3809; F02D 2041/389

(57) ABSTRACT

A dual-mode fuel injector has an internal part containing a variable volume chamber space which fills with fuel at common rail pressure and a plunger which is operable to force fuel out of the variable volume chamber space and to be injected out of the nozzle through the injection orifices at amplified pressure greater than common rail pressure. The plunger and the internal part have respective surfaces which come into mutual abutment during filling of the variable volume chamber space with fuel at common rail pressure and which, when in mutual abutment, create a seal which seals fuel in the variable volume chamber space against escape from the variable volume chamber space past the seal.

### TECHNICAL FIELD

This disclosure relates to internal combustion engines having cylinders into which fuel is injected, and in particular to a fuel injector which injects liquid fuel directly into an engine cylinder.

### BACKGROUND

A known type of direct-injection fuel injector which is supplied with fuel from a fuel rail, inside of which liquid fuel is under pressure, possesses a capability for injecting fuel into an engine cylinder in either of two fuel injection modes. Those modes may be referred to as a common rail injection mode and an amplified pressure injection mode. When operating in the former mode, the fuel injector injects fuel at prevailing pressure in a fuel rail (i.e., common rail pressure); when operating in the latter mode, the fuel injector injects fuel at amplified pressure which is greater than common rail pressure.

Such a fuel injector comprises a pressure amplifying mechanism for internally amplifying pressure of fuel which has been introduced into the fuel injector from the fuel rail. Various types of pressure amplifying mechanisms are known.

In both modes of operation, fuel is injected out of the fuel injector through injection orifices at a tip end of a nozzle which is disposed within a head end of an engine cylinder when the fuel injector is mounted on the cylinder head.

The nozzle is one part of a nozzle assembly which comprises a needle control mechanism which closes a fuel path to the injection orifices by causing a needle to be biased against a seat so that fuel cannot be injected out of the injection orifices into an engine cylinder. In both common rail injection mode and amplified pressure injection mode, injection occurs when a needle control valve associated with the needle control mechanism is operated to cause the needle to unseat from the seat and consequently open the fuel path to the injection orifices so that fuel can be injected out of the injection orifices into the engine cylinder.

Unseating of the needle occurs by electrically energizing an injection actuator to operate the needle control mechanism and thereby allow fuel, which may be either at common rail pressure or at amplified pressure, to flow lengthwise along the needle through a space between the needle and a surface of an interior wall of the nozzle which surrounds the needle, past the seat, and through and out of the injection orifices.

### SUMMARY OF THE DISCLOSURE

The present disclosure relates to a fuel injector which is selectively operable to a common rail injection mode and an amplified pressure injection mode.

The fuel injector has a longitudinal axis and comprises a body having a fuel inlet port through which liquid fuel is introduced into the body at a common rail pressure and a nozzle assembly disposed at an axial end of the body. The nozzle assembly comprises a nozzle having injection orifices at a tip end of the nozzle and a needle which is disposed within the nozzle and is biased axially against a seat to close the injection orifices to fuel in the body and an electric injection control actuator.

When energized while the fuel injector is in common rail injection mode, the electric injection control actuator is effective to cause the needle to be unseated from the seat and fuel to be injected out of the nozzle through the injection orifices at common rail pressure.

A pressure-amplifying mechanism is internal to the body and comprises an internal part containing a variable volume chamber space which, when the electric injection control actuator is not being energized, fills with fuel at common rail pressure from the fuel inlet port, and a plunger which when the electric injection control actuator is energized to unseat the needle from the seat while the fuel injector is in the amplified pressure injection mode, is operable to force fuel out of the variable volume chamber space and to be injected out of the nozzle through the injection orifices at amplified pressure greater than common rail pressure.

The plunger and the internal part comprise respective surfaces which come into mutual abutment during filling of the variable volume chamber space with fuel at common rail pressure and which, when in mutual abutment, create a seal which seals fuel in the variable volume chamber space against escape from the variable volume chamber space past the seal.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a longitudinal cross section view of one embodiment of a dual-mode fuel injector which is capable of operating in a common rail injection mode and an amplified pressure injection mode.

FIG. 2 is an enlarged fragmentary view in circle 2 of FIG. 1 showing further detail.

FIG. 3 is an enlarged fragmentary view in circle 3 of FIG. 1 showing further detail.

FIG. 4 is a view of a portion of another embodiment.

FIG. 5 is a view of a portion of still another embodiment.

FIG. 6 is a view of a portion of still another embodiment.

### DETAILED DESCRIPTION

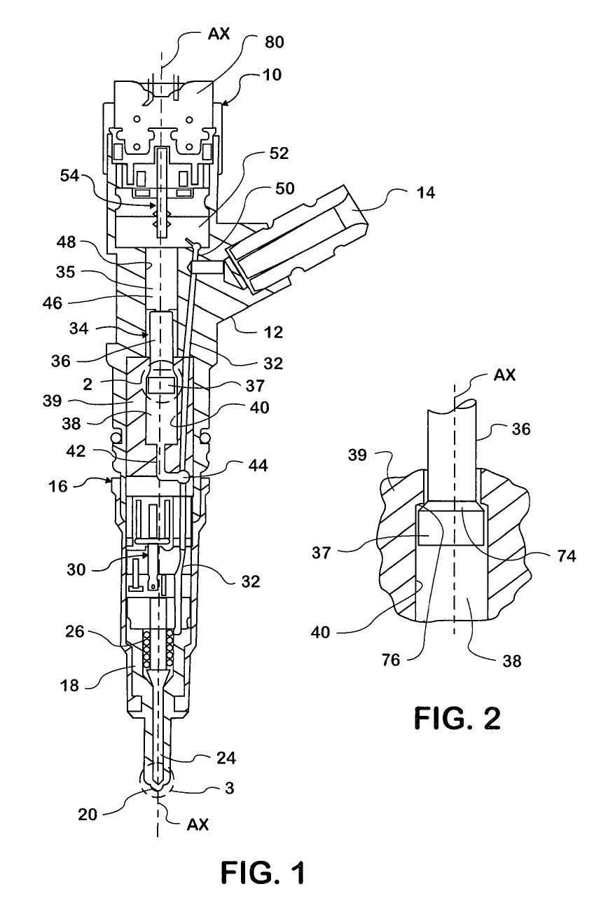

FIGS. 1, 2, and 3 show a fuel injector 10 which mounts on a cylinder head of an engine (not shown) and which is operable to inject liquid fuel directly into one of the engine's cylinders where the injected fuel combusts in charge air which has entered the engine cylinder to force a piston to downstroke within the engine cylinder and impart torque to a crankshaft through a piston rod.

Fuel injector 10 has an imaginary longitudinal axis AX and comprises a body 12 having a fuel inlet port 14 through which liquid fuel is introduced into internal fuel passages within body 12. Fuel is provided to fuel inlet port 14 through a fuel rail (not shown) which serves multiple fuel injectors of a multiple cylinder engine. The fuel rail provides fuel to the fuel injectors at a controlled pressure referred to as common rail pressure.

At one axial end of body 12, fuel injector 10 comprises a nozzle assembly 16 which has an axially extending nozzle 18 having a tip end 20 which comprises injection orifices 22 through which fuel is injected out of fuel injector 10 when the fuel injector operates. Nozzle assembly 16 further comprises a needle 24 which is guided by a surrounding internal wall surface of nozzle 18 for displacement along axis AX. A spring 26 biases needle 24 to seat a needle tip end against an internal tapered seat 28 which is axially inward of injection orifices 22 on the internal wall surface of nozzle 18.

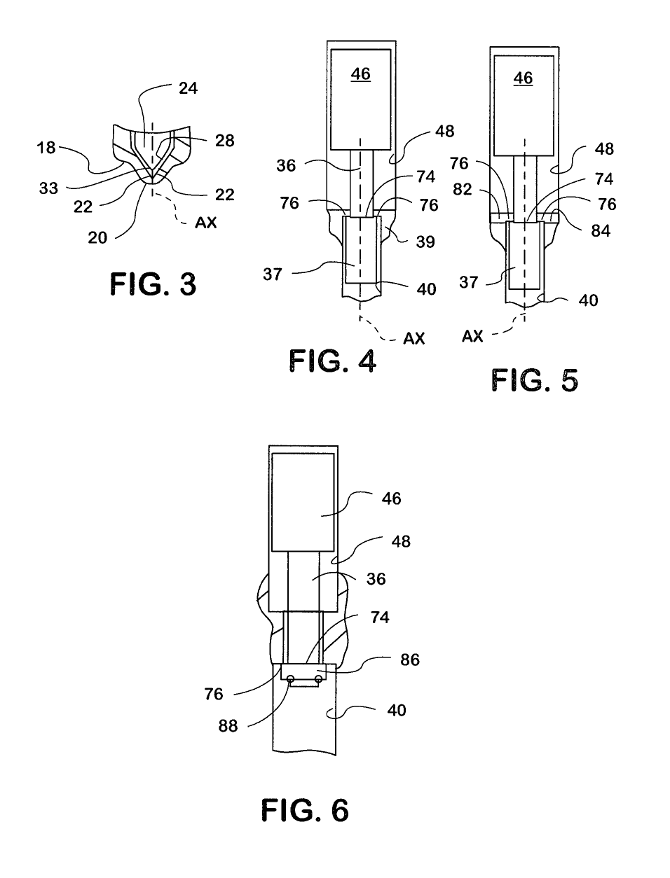

An electric-operated injection control actuator 30 is operable to cause fuel to be injected through and out of injection orifices 22 during an injection of fuel into an engine cylinder. An injection of fuel is caused by electrically energizing injection control actuator 30 to unseat needle 24 from seat 28 and thereby open injection orifices 22. Along the axial length of nozzle 18, slight radial clearance exists between needle 24 and the internal wall surface of nozzle 18 for fuel to flow through a fuel passage 32 and to continue along the needle's length to seat 28. When electric energization of injection control actuator 30 ceases, needle 24 re-seats on seat 28 to close injection orifices 22 thereby terminating the fuel injection. With needle 24 seated, FIG. 3 shows a small space 33, commonly called a sac volume, between seat 28 and injection orifices 22.

With fuel injector 10 operating in common rail injection mode and injection control actuator 30 not being electrically energized, fuel at common rail pressure is present along the full length of fuel passage 32 and the radial clearance between needle 24 and the surrounding internal wall surface of nozzle 18 as far as seat 28. When injection control actuator 30 is electrically energized, the unseating of needle 24 opens injection orifices 22 to allow fuel flow from inlet port 14 to injection orifices 22, thereby causing an injection of fuel at common rail pressure, understood to be actual pressure in the common rail less whatever internal pressure drop may be present in fuel injector 10.

Fuel injector 10 also comprises a pressure amplifying mechanism 34 which has a movement 35 comprising a plunger 36 which is axially displaceable within a variable volume chamber space 38 of an internal part 39. A lower end portion 37 of plunger 36 has a close sliding fit to an inner wall surface 40 of part 39 which surrounds variable volume chamber space 38. Variable volume chamber space 38 can be filled with fuel through a passage 42 which branches from passage 32 to the bottom of variable volume chamber space 38.

A check valve element 44 is disposed at the intersection of passage 42 and passage 32. In common rail injection mode, pressure amplifying mechanism 34 does not operate, causing check valve element 44 to assume a position which allows passage 42 to be open to passage 32 and passage 32 to be open along its entire length from inlet port 14 to injection orifices 22. In amplified pressure injection mode, pressure amplifying mechanism 34 operates to cause fuel to be injected at amplified pressure, a pressure greater than common rail pressure, by forcing check valve element 44 to close the portion of passage 32 coming from inlet port 14 while leaving passage 42 open to the portion of passage 32 extending from passage 42 to seat 28.

Movement 35 further comprises a piston 46 which is axially displaceable within a bore 48 with a close sliding fit and which has a lower axial end face abutting an upper axial end face of plunger 36. Plunger portion 37 has a smaller diameter than that of piston 46.

FIG. 1 shows a condition where variable volume chamber space 38 is filled with fuel at common rail pressure which has flowed from fuel inlet port 14 through passage 32 and passage 42 and into variable volume chamber space 38.

A passage 50 extends from fuel inlet port 14 to a valve mechanism 52 which is operable to open and close passage 50 to the upper end of bore 48 while concurrently closing and opening a drain passage from the upper end of bore 48, the drain passage not being visible in the view of FIG. 1. Valve mechanism 52 is controlled by an electric-actuated injection pressure control actuator 54.

When injection pressure control actuator 54 is not electrically energized, valve mechanism 52 closes passage 50 to the upper end of bore 48 and opens the drain passage from the upper end of bore 48. When injection pressure control actuator 54 is electrically energized, it causes valve mechanism 52 to open passage 50 to the upper end of bore 48 while closing the drain passage so that fuel at common rail pressure acts on the upper axial end face of piston 46, thereby placing fuel injector 10 in pressure amplifying mode.

Because of the difference in the respective diameters of piston 46 and plunger lower end portion 37, placement of fuel injector 10 in pressure amplifying mode creates a downward force on movement 35 which is effective to cause check valve element 44 to close the portion of passage 32 coming from inlet port 14 while leaving passage 42 open to the portion of passage 32 extending from passage 42 to seat 28. This creates amplified pressure in variable volume chamber space 38, passage 42, and the portion of passage 32 extending from passage 42 to seat 28.

When injection control actuator 30 is electrically energized to cause an injection of fuel, the downward force acting on movement 35 imparts downward displacement to movement 35 as fuel passes through valve mechanism 52 into bore 48. The force maintains amplified pressure on fuel being forced out of variable volume chamber space 38, through passage 42, and through the portion of passage 32 extending from passage 42 past seat 28 to injection orifices 22, thereby causing fuel to be injected out of injection orifices 22 at amplified pressure.

As long as injection control actuator 30 continues to be electrically energized and movement 35 continues to force fuel out of variable volume chamber space 38, fuel is injected out of injection orifices 22 at amplified pressure.

Energization of injection control actuator 30 terminates before variable volume chamber space 38 is completely emptied, thereby terminating amplified injection. Immediately after injection control actuator 30 ceases being energized, energization of injection pressure control actuator 54 also ceases, causing valve mechanism 52 to close passage 50 to bore 48 while opening the drain passage from bore 48. Because amplified pressure has now been lost, check valve element 44 ceases being forced to close the portion of passage 32 coming from inlet port 14, thereby allowing fuel from fuel inlet port 14 to refill variable volume chamber space 38 as pressure of fuel entering variable volume chamber space 38 exerts upward force on plunger 36 which displaces movement 35 upwardly and causes piston 46 to force fuel out of bore 48 through the drain passage.

Upward displacement of movement 35 continues until stopped by a surface 74 of plunger 36 coming into abutment with a surface 76 of part 39 at which point variable volume chamber space 38 has become refilled. Surface 74 has a frustoconical shape whose taper narrows in the direction away from lower end portion 37 of plunger 36. Surface 76 has a frustoconical shape whose taper also narrows in the same direction along axis AX but at a different cone angle.

Surfaces 74, 76 provide plunger 36 and the inner wall of part 39 with respective tapered shoulders which come into mutual abutment to stop plunger displacement. Hence, surfaces 74, 76, when mutually abutted, define not only an upward axial limit of travel for plunger 36 but also a seal which prevents flow of fuel at common rail fuel pressure in variable volume chamber space 38 past the seal, meaning past movement 35 and into the drain passage. By preventing flow of fuel at common rail fuel pressure from variable volume chamber space 38 past movement 35 while injection control actuator 30 is not energized, energy which creates common rail pressure is conserved.

Electric current for energizing the respective actuators 30, 54 is carried through electric conductors from an electric terminal assembly 80 on fuel injector 10 above actuator 54.

From the foregoing description, it can be understood that in either mode of operation, the duration of an injection of fuel out of injection orifices 22 is controlled by the duration for which injection control actuator 30 is energized.

FIG. 4 shows an embodiment where surface 74 of plunger 36 and surface 76 of part 39 lie in planes perpendicular to axis AX.

FIG. 5 shows an embodiment where surface 74 of plunger 36 lies in a plane perpendicular to axis AX as in FIG. 4. Surface 76 however is provided by a flat circular washer 82 which is secured in place against a shoulder 84 located at the junction of surfaces 40 and 48 and which has an inside diameter smaller than that defined by surface 40.

FIG. 6 shows another embodiment where surface 76 of part 39 lies in a plane perpendicular to axis AX. Surface 74 also lies in a plane perpendicular to axis AX but is contained in a separate part 86 (corresponding to plunger portion 37 in FIG. 1) which is fastened to plunger 36 by a fastener 88. The radial clearance between part 86 and the wall surface 40 is shown somewhat exaggerated.

What is claimed is:

1. A fuel injector which is selectively operable to a common rail injection mode and an amplified pressure injection mode, the fuel injector having a longitudinal axis and comprising:
a body having a fuel inlet port through which liquid fuel is introduced into the body at a common rail pressure;
a nozzle assembly disposed at an axial end of the body, the nozzle assembly comprising a nozzle having injection orifices at a tip end of the nozzle and a needle which is disposed within the nozzle and is biased axially against a seat to close the injection orifices to fuel in the body;
an electric injection control actuator which when energized while the fuel injector is in common rail injection mode, is effective to cause the needle to be unseated from the seat and fuel to be injected out of the nozzle through the injection orifices at common rail pressure;
a pressure-amplifying mechanism which is internal to the body and comprises an internal part containing a variable volume chamber space which, when the electric injection control actuator is not being energized, fills with fuel at common rail pressure from the fuel inlet port, and a plunger which when the electric injection control actuator is energized to unseat the needle from the seat with the fuel injector in the amplified pressure injection mode, is operable to force fuel out of the variable volume chamber space and to be injected out of the nozzle through the injection orifices at amplified pressure greater than common rail pressure; and
the plunger and the internal part comprising respective surfaces which come into mutual abutment during filling of the variable volume chamber space with fuel at common rail pressure and which, when in mutual abutment, create a seal which seals fuel in the variable volume chamber space against escape from the variable volume chamber space past the seal.

2. The fuel injector as set forth in claim 1 in which the respective surfaces which come into mutual abutment during filling of the variable volume chamber space with fuel at common rail pressure comprise respective frustoconical surfaces having different cone angles.

3. The fuel injector as set forth in claim 1 in which the respective surfaces which come into mutual abutment during filling of the variable volume chamber space with fuel at common rail pressure comprise respective flat surfaces which are perpendicular to the longitudinal axis.

4. The fuel injector as set forth in claim 3 in which one of the respective flat surfaces comprises a surface of a circular washer secured in place on the internal part.

5. The fuel injector as set forth in claim 3 in which one of the respective flat surfaces comprises a surface of a part assembled to the plunger by a fastener.
